(19) United States
(12) Patent Application Publication
(10) Pub. No.: US 2025/0282281 A1
(43) Pub. Date: Sep. 11, 2025

(54) Multi-Directional U-Turn Signal Device For Motor Vehicles

(71) Applicants: Veronica A Carew, Orlando, FL (US); Benjamin O. Yearwood, Manchester, NJ (US)

(72) Inventors: Veronica A Carew, Orlando, FL (US); Benjamin O. Yearwood, Manchester, NJ (US)

(21) Appl. No.: 18/601,737

(22) Filed: Mar. 11, 2024

(51) Int. Cl. B60Q 1/26; B60Q 1/00; B60Q 1/50

(52) U.S. Cl. CPC B60Q 1/268; B60Q 1/0076; B60Q 1/503; B60Q 2400/20; B60Q 2900/10

(57) ABSTRACT

A u-turn signal device comprised of three or more u-turn signal lights that are located inside the passenger compartment of the motor vehicle on one or more of the windows or visors of the motor vehicle (e.g., driver's visor, passenger's visor, front windshield, rear window, side window), in a place that will not unnecessarily block the view of the driver of the motor vehicle, but which will signal a u-turn to persons outside of the motor vehicle.

### FIELD OF THE INVENTION

The invention relates to a u-turn signal device for motor vehicles.

### BACKGROUND OF THE INVENTION

It is well known that motor vehicles in the United States provide turn signal lights for drivers to use when they are making both left turns and right turns. However, these signal lights do not distinguish between making left turns and u-turns, creating potential safety issues for other drivers, bicycle riders, pedestrians, and others in the area, by not signaling exactly what the driver intends to do.

Several methods for indicating a u-turn on a motor vehicle have been proposed but they suffer from various shortcomings, disadvantages and impracticalities that render the incorporation of these schemes into existing and future automobiles unlikely and un-useful. For example, almost all of the prior art devices, proposed to address this problem, require that elements of the device be mounted on the exterior of the motor vehicle, or be incorporated into the automobile integrated system. Drawbacks to this are that the device must be ruggedized to survive the extremes of temperature, precipitation and road conditions to an equivalent degree as the motor vehicle itself. This drives device cost higher and degrades overall vehicle reliability. Another huge drawback to this aspect of prior art is that the motor vehicle itself requires substantial physical modification in order to utilize the device. By having to drill holes in the vehicle body to run wiring or affixing strong adhesive or fasteners, to attach elements of the device to the vehicle exterior, is undesirable by automobile owners and could negatively impact automobile manufacturer warrantees. Most of these prior art schemes seem best suited for incorporation in new automobile production. However, the lead time to design and incorporate a new motor vehicle system into production is many years. This makes these devices very problematic to incorporate into the existing stock of the millions of automobiles currently operating around the world. Another aspect of the drawbacks to mounting elements of these prior art devices on the exterior of vehicles is that these devices will necessarily be unsightly (ugly). One of the reasons a person purchases an automobile is the esteem that the designed-in beauty of the vehicle imparts to the person. It would be almost impossible to match the appearance of these devices with the design motif of the vehicles to which they are being affixed. It will also be difficult to match the body contours, vehicle color and variations in these from model to model. Another weakness in prior art devices is that they do not offer a u-turn signal that is visible 360 degrees around the vehicle to a significant distance. Many prior art devices mount some sort of special u-turn signal near the front and rear left turn signal of a vehicle. This location has some benefit but is limited in that the signal is not visible to other vehicle operators or pedestrians, not in the immediate vicinity of the u-turning vehicle, but that are close enough to that vehicle to make certain driving judgements, because of the u-turning vehicle. The best location for a u-turn signal, in order to maximize visibility, is to mount the signal as high on the vehicle as possible. The level of the windows of the passenger compartment of a motor vehicle is an ideal mounting location for such a signal. The invention presented here addresses these problems by having a u-turn signal device that is completely mounted inside the passenger compartment of the vehicle and that provides the ability to have a 360 degree field-of-view of the u-turn signal.

Improved and alternative devices and methods for making safer u-turns are thus needed. Such improved and alternative devices and methods may be more readily noticed by other users of the road in order to make more visible and/or safer u-turns, more easily installed and maintained, and better protected from the outside elements.

### SUMMARY OF THE INVENTION

U-turn signal devices are provided for a motor vehicle (including, automobile, car, motorcycle, van, truck, bus, etc., whatever the power source (e.g., electrical, gas, diesel, propane, hydrogen)) by embodiments of this invention. The devices may be provided with multiple components including one or more u-turn signal lights (e.g., containing light bulbs, light bulb sockets or Light-Emitting Diodes (LED)), also sometimes referred to herein as “emitters” or “lighted signal devices”, connected to a switch and an electrical source (e.g., the automobile electrical power), as well as other possible components apparent to a person of skill in the art reading this specification.

Certain preferred embodiments provide a u-turn signal device comprised of three or more u-turn signal lights or emitters that are located inside the passenger compartment of the motor vehicle on one or more of the windows or visors of the motor vehicle (e.g., driver's visor, passenger's visor, front windshield, rear window, side window), in a place that will not unnecessarily block the view of the driver of the motor vehicle, but which will signal a u-turn to persons outside of the motor vehicle. This u-turn signal shall be omnidirectional. It will be visible in every direction around the motor vehicle, or, optionally, multidirectionally. That is, visible in the key directions necessary to alert drivers and pedestrians of the driver's intent to execute a u-turn.

The u-turn signal devices of this invention are comprised of three or more u-turn signal lights that are bright enough for someone outside the motor vehicle to see. One of skill in the art knows the different light sources that are used on motor vehicles for signaling (e.g., LED bulbs, incandescent bulbs, halogen bulbs, xenon bulbs) and can apply them to this invention. One of skill in the art also knows what types of sockets, receptacles and housings for lights are used on motor vehicles and for signals and how to provide them with electrical circuits with switches for the drivers to use to turn them on and off with electrical connections from the motor vehicle itself to power the light sources according to the switch positions.

The u-turn signal devices of this invention can provide u-turn signal lights in a particular shape (e.g., lens shape that may affect the focus and direction of the light), particular color or colors (e.g., red, yellow, green), particular intensities (e.g., low, medium, bright) or particular desired flashing or a constant light. In certain embodiments letters and/or words indicating “u-turn” (e.g., “uturn”, “u turn”, “u-turn”, “U TURN”, “U-TURN”), or other shapes or forms to further communicate the taking of a u-turn, by having one or more light bulbs, passing the light through a lens, past an obstruction (e.g., cut-out, form, symbol) to form a silhouette, or other ways to form a desired shape, such as LED). Flexibility exists in the design to allow the u-turn signal to be shaped and communicated in the linguistic and cultural context of the particular motor vehicle operator community. Thus different letters and symbols can be used to form the u-turn signal that is different to that which is customary in the United States or English speaking countries.

The u-turn signal device of this invention may provide for the turning on and off of the u-turn signal lights by the driver manually by utilizing an on/off toggle switch.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE DRAWINGS

FIG. 1 is a schematic of an intersection on a road where this invention may be potentially used by a motor vehicle to make a u-turn.

FIG. 2 is a schematic of an alternative situation on a road where this invention may potentially be used by a motor vehicle to make a u-turn.

FIG. 3 is a schematic of an intersection on a road (like that of FIG. 1) with a possible u-turn to be taken by a motor vehicle illustrated.

FIG. 4 is a schematic of an alternative situation on a road (like that of FIG. 2) with a possible u-turn to be taken by a motor vehicle illustrated.

FIGS. 5A-5C show views of a mini-van motor vehicle (A: front, B: driver's side, C: rear window), with potential placements of u-turn signal lights of embodiments of this invention

FIGS. 6A-6C show views of a pick-up truck motor vehicle (A: front, B: driver's side, C: rear window), with potential placements of u-turn signal lights of embodiments of this invention.

FIGS. 7A-7C show views of an SUV motor vehicle (A: front, B: driver's side, C:
rear window), with potential placements of u-turn signal lights of embodiments of this invention.

FIGS. 8A-8C show views of a sedan motor vehicle (A: front, B: driver's side, C: rear window), with potential placements of u-turn signal lights of embodiments of this invention.

FIGS. 9A-9B show views of a motor vehicle, with potential placements of u-turn signal lights of embodiments of this invention (A: passenger side middle window placement, B: passenger side back window placement).

FIGS. 10A-10C show views (A: looking forward from a rear seat, B: looking towards the rear from a front seat; C: looking at the side of the vehicle) of the interior of a motor vehicle and the placement of components of a u-turn signal device embodiment of this invention.

FIGS. 11A-11C show views (A: looking forward from a rear seat showing possible locations of u-turn lighted signal device components, B: looking into a console between the front seats showing vehicle electrical outlets that may be used to power the u-turn lighted signal devices; C: looking at the passenger side from the outside of the rear doors of the vehicle into the interior of a motor vehicle and showing the placement of vehicle electrical outlets that may be used to provide electric power for the operation of the u-turn lighted signal devices.

FIG. 12 is a schematic of an electrical circuit connected to components of an embodiment of this invention, using all wired components.

FIG. 13 is a schematic of an electrical circuit connected to components of an embodiment of this invention, using certain wireless components.

FIGS. 14A and B are u-turn lighted signal devices. FIG. 14A shows a perspective view of a u-turn lighted signal lights to be mounted on motor vehicle driver side and front passenger side visors. FIG. 14 B shows a perspective view of a of u-turn signal light to be mounted on motor vehicle passenger compartment windows. These will be compatible with the front window, passenger compartment door windows that to not fully roll down into the door (there must be enough window remaining outside the door to mount the u-turn signal device—also roll down window mounting may ideally utilize the device wireless embodiment), vehicle side windows (such as vent windows), and the rear window of the motor vehicle.

### DETAILED DESCRIPTION OF THE INVENTION

In the following description, numerous specific details are set forth to clearly describe the embodiments disclosed herein. However, one skilled in the art will understand that some well-known features have not been described in detail so as not to obscure the invention.

A u-turn signal device is provided by this invention with multiple components. Included are several u-turn lighted signal devices. A minimum of three lighted signal devices are necessary to achieve safe u-turn signaling multi-directionally. In this configuration one lighted signal device must be mounted to face forward. Another must be mounted to face the driver's side. And the third must be mounted to face towards the rear of the motor vehicle. This configuration provides the minimum safety to the motor vehicle operator, and is considered, in itself, superior to the prior art. Four u-turn lighted signal devices are required to achieve a full 360 degree, omnidirectional u-turn signal. This configuration is the preferred embodiment and affords the maximum safety to the motor vehicle operator. This improves vehicular and pedestrian safety by enabling people to distinguish between left turns and u-turns.

The components of the u-turn signal device of this invention comprise three, four and possibly more u-turn lighted signal devices, one switch device that turn the u-turn-signal lights on and off, and an electrical circuit that connects the u-turn signal lights to the switches by wires and/or wirelessly and one or more sources of electricity (e.g., a car battery, a car alternator). The device may be completely wired, and include components such as the u-turn signal lights, mounting for the lights, wiring, a controller, a plug, and a switch (e.g., toggle switch). The device may also have wireless features comprised of components such as wireless receiver electronics, a wireless receiver, control electronics, a toggle switch, a wireless transmitter, wiring, plug(s), and separate batteries for each wireless u-turn lighted signal device. The u-turn signal device embodiment utilizing wireless features will also include special design provisions such that, if a driver turns on the signal device, that it will not inadvertently turn on the wireless components of a signal device located in a nearby vehicle. This may be accomplished via signal encoding, by utilizing special electronic switching provisions or by other means.

The u-turn signal lights may be rectangular, oval or circular, or another shape to fit with the look and style fashionable with automobile interiors at a particular time, and that also maximizes the visibility of the u-turn signal. The u-turn lighted signal devices shall be mounted, and shall operate, completely in the motor vehicle passenger compartment. The u-turn lighted signal devices shall be mountable on the driver side, and front passenger side visor by utilizing a friction grip mount that will be integral with those u-turn lighted signal devices. The passenger-side front visor mounted lighted signal device shall be rotated downward, by so rotating the visor, so that the emitted light will be visible through the front windshield. The driver-side front visor mounted lighted signal device shall be rotated downward, then side-ways, by so rotating the visor, so that the emitted light will be visible through the driver-side door window. Another embodiment of the u-turn lighted signal device shall be mounted via adhesion to the insides of the various passenger compartment windows. This includes the front windshield (preferably mounted low so as not to obscure the drivers field of front visibility). They may be mounted on side windows where the window does not completely roll down into the vehicle door (the u-turn signal device will be mounted on the portion of the window that does not roll down into the door (there must be enough room on the section of window that does not roll down into the door in order to mount the u-turn lighted signal devices at these locations)). They may be mounted on rear or rear vent side windows that may or may not be part of a door. They shall be mounted on the inside of the rear window in a location that does not obscure the driver's rear field of view.

The u-turn signal lights in some embodiments can use various letters, words and possibly other symbols to create the u-turn warning signal. The preferred embodiment utilizes letters and/or words that spell out or indicate “u-turn” in some form (e.g., “uturn”, “u turn”, “u-turn”, “U-turn”, “U TURN”, “U-TURN”). They may be of any suitable shape and color that gets the attention of those outside of the vehicle. The light may shine continuously or it may blink, flash, or repeat in a pattern. The light may take a certain form from the source (e.g., bulb or bulbs) that provides the light, or it may take a form from a shape and/or lens it passes through. The light may be provided by any lights used for signaling by motor vehicles (e.g., LED bulbs, incandescent bulbs, halogen bulbs, xenon bulbs), and be in an appropriate housing to keep out dust and dirt, and to protect the light source from extremes of heat and cold. The device shall be simple and safe to install, inside the vehicle passenger compartment, by a lay person who does not possess the knowledge and skill of a professional automobile repair person.

A motor vehicle with a trailer, that is required to have a turn signals, can use this invention. For example, a u-turn signal light of this invention may be installed on the rear of the trailer. This is accomplished via an additional embodiment of the u-turn signal lights that is affixable and ruggedized for mounting and operation outside the passenger compartment of a motor vehicle. The electrical power source for this embodiment of u-turn signal light can be that used to power the left turn, right turn and brake signal lights of the trailer. Motor vehicles with trailer hitches also typically have provisions for vehicle wiring run to, and connected to, the trailer. This u-turn signal light will need to be designed with additional ruggedness to withstand the weather, temperature variations, and precipitation, that will be encountered as a result of operation outside the motor vehicle. There will also need to be special provisions provided to connect the on/off toggle switch signal to the exterior mounted u-turn signal light. One approach may be to place wireless repeaters on the exterior of the trailer that will transmit the signal from the toggle switch, mounted inside the motor vehicle, to a u-turn signal light mounted on the rear of a trailer. Another possible approach is to have a professional automobile repair person hard-wire the toggle switch to the motor vehicle wiring that operates the trailer turn and brake signals.

The preferred embodiment of the u-turn signal device is intended to be packaged as a kit. However, an additional embodiment will also be able to be installed with the original equipment of the motor vehicle when the motor vehicle is manufactured or refurbished. The preferred embodiment of this invention will be provided as a kit that can be used to retrofit an existing motor vehicle with the multidirectional or omnidirectional u-turn signal device.

In the preferred embodiment of this invention, the entire u-turn signal device and all of its components are installed quickly and easily by a layperson in the interior passenger compartment of the motor vehicle. The u-turn signal lights of the device are affixed to visors and/or windows on the interior of the motor vehicle so that they can be seen from outside the motor vehicle.

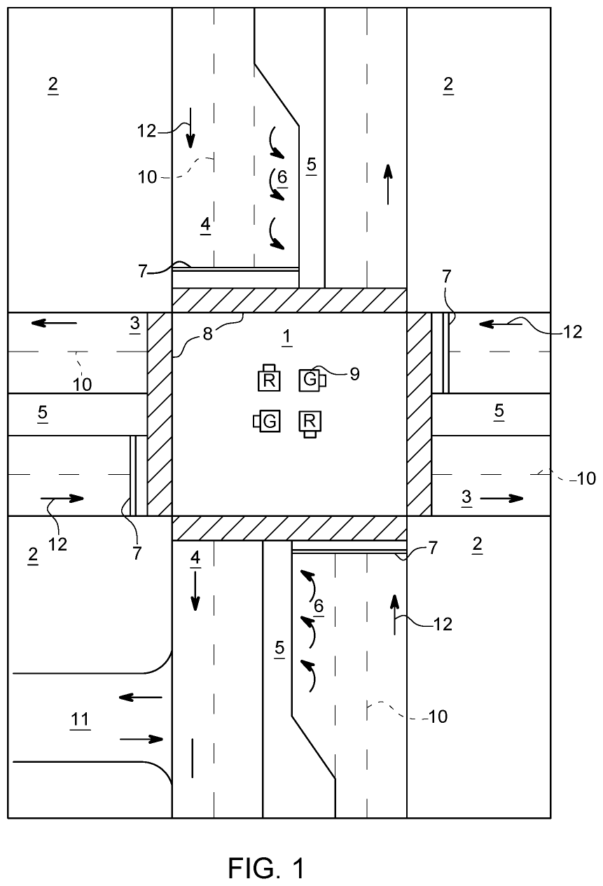

FIG. 1 depicts a typical four-way intersection [1] and parts thereof. Land with buildings and commerce [2] are shown with a first intersecting highway/roadway [3] and a second intersecting highway/roadway [4], which together form the intersection [1]. Highway/roadway dividers [5] are present, along with dedicated turning lanes [6], a stop line [7], pedestrian crosswalks [8], traffic lights (G=Green (Go); R=Red (Stop)) [9], roadway lane lines [10], an exemplary driveway [11], and a traffic direction indicator [12], which in the United States is for a driver on the left to keep right by convention.

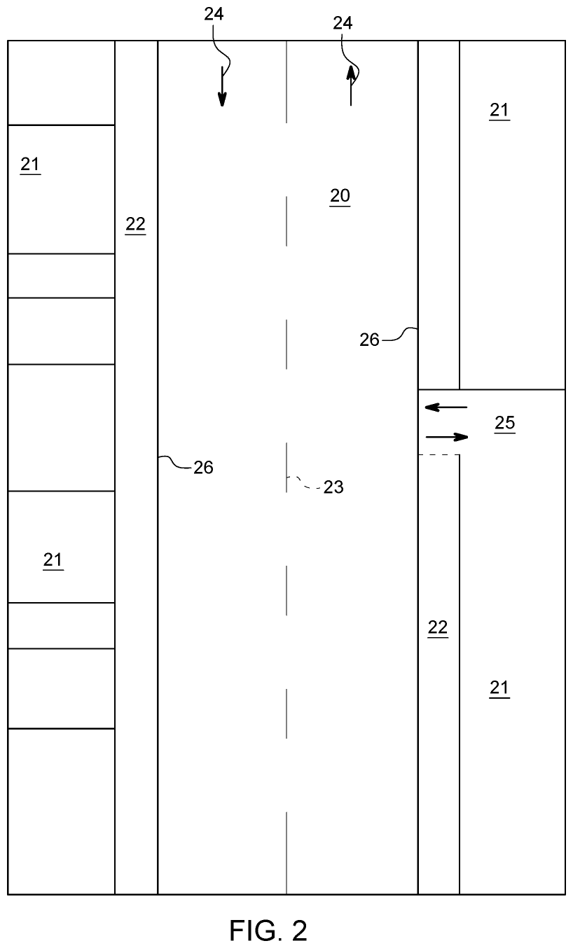

FIG. 2 depicts a typical city street [20] and parts thereof. Land with buildings and commerce [21] are shown with a sidewalk [22], road centerline [23], and traffic direction indicator [24], which in the United States is for a driver on the left to keep right by convention, an exemplary driveway, as shown by arrows [25], and a curb [26].

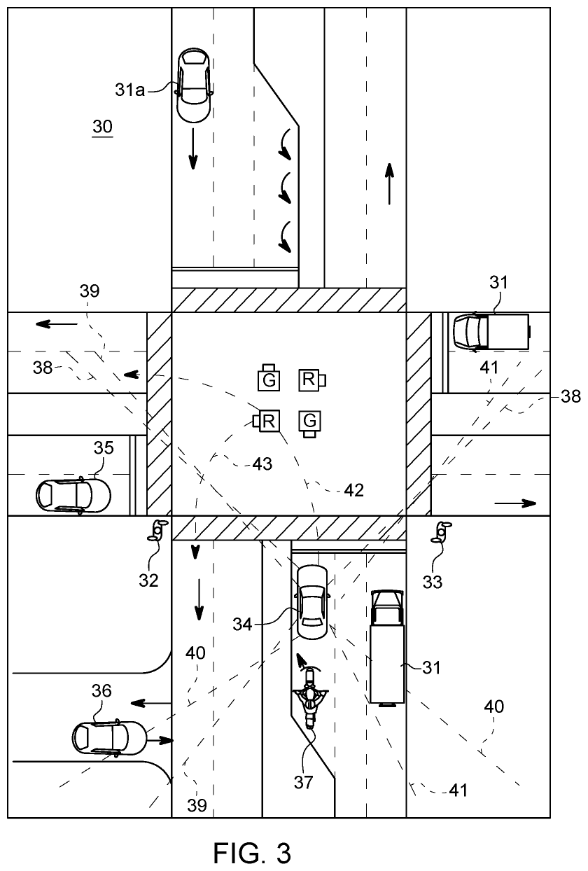

FIG. 3 depicts a u-turn executed in a four-way intersection like that of FIG. 1. A common u-turn scenario is shown [30], as well as motor vehicles of various types [31], pedestrians [32], [33], a motor vehicle executing a u-turn at the intersection [34], a motor vehicle operating contemplating executing a right-on-red [35], a motor vehicle pulling out of a driveway potentially in path of a u-turning vehicle [36], a motor vehicle following the u-turning vehicle [37], the field-of-view of a forward-facing lighted u-turn signal light component of a u-turn signal device embodiment of this invention [38], the field-of-view of the driver-side facing lighted u-turn signal light component of a u-turn signal device embodiment of this invention [39], the field-of-view of the rear-facing lighted u-turn signal light component of a u-turn signal device embodiment of this invention [40], the field-of-view of an optional right side lighted u-turn signal light component of a u-turn signal device embodiment of this invention (this enables complete 360 degree omnidirectional signaling), the presumed path of the turning vehicle [42], and the actual path of the turning vehicle [43].

FIG. 3 further shows the interaction of the participants at an active roadway intersection [30], with various motor vehicles in the intersection [31] and pedestrians in the intersection [32], [33]. The driver of a vehicle [34], utilizing an installed, turned-on, u-turn signal device embodiment of this invention, is executing a u-turn. The driver of a particular vehicle [35] is contemplating making a right-on-red that would result in that vehicle crossing the path of the u-turning left turning vehicle. Another vehicle is pulling out of a driveway [36], and this maneuver would result in that vehicle crossing the path of the u-turning vehicle. Another motor vehicle [37] will be following the u-turning vehicle as they make the left turn. Pedestrian [32] is contemplating crossing the roadway in the crosswalk. This will result in the pedestrian crossing the path of the u-turning vehicle. A vehicle [31A] is approaching the intersection and will need to adjust speed depending on whether the u-turning vehicle makes a left turn or a u-turn.

The dashed lines in FIG. 3 show the field-of-view of each of the lighted u-turn signal lights of this invention. The forward-facing u-turn signal light field-of-view is shown [38]. The driver-side u-turn signal light field-of-view is shown 39. The rear-facing u-turn signal light field-of-view is shown [40]. The u-turning vehicle right-side-facing u-turn signal light field-of-view is shown [41]. Prior to entering the intersection, the driver of the u-turning vehicle enables the u-turn signal device of this invention, installed in the vehicle, and also signals a left turn using the vehicle turn signal. A minimum installation of the forward facing, driver-side facing and the rear facing lighted u-turn signal light, on the u-turning vehicle, provides effective multi-directional warning for the most at-hazard vehicles and pedestrians affected by the u-turn. By utilizing a fourth, passenger side facing, u-turn signal device affords communication of a full omnidirectional u-turn warning signal. This is the preferred embodiment and provides the most safety during the execution of a u-turn.

By adding a fourth lighted u-turn signal light to the device depicted in FIG. 3, installed with a field of view out of the right side of the u-turning vehicle, this creates a true and/or effective omnidirectional warning signal. This omnidirectional signal embodiment minimizes the hazards associated with u-turns and can warn other drivers and pedestrians that the u-turning driver may not ordinarily consider. An example is the pedestrian [33] shown. Vehicles making left turns, normally cross the pedestrian crosswalk path only once. However, for a u-turning vehicle, under the circumstances shown, the u-turning vehicle will cross the pedestrian's path twice. The pedestrian [33] will have to take this into account in order to safely cross the roadway. With the u-turn signal device turned off, all drivers and pedestrians, in the intersection assume the u-turning vehicle [34] will be making a left turn following the path [42] shown. This discontinuity of expectations creates hazards for u-turning vehicles and pedestrians and, also for the other vehicles and pedestrians interacting with the u-turning vehicle. By utilizing the u-turn signal device of this invention, all competent, un-impaired and undistracted drivers, within the 360 degree omnidirectional effective field-of-view, and having direct line-of-sight to the u-turning vehicle, all understand that the u-turning vehicle will be taking the path shown [43]. This community understanding, of the intentions of the u-turning driver, reduces hazard and enhances driving safety.

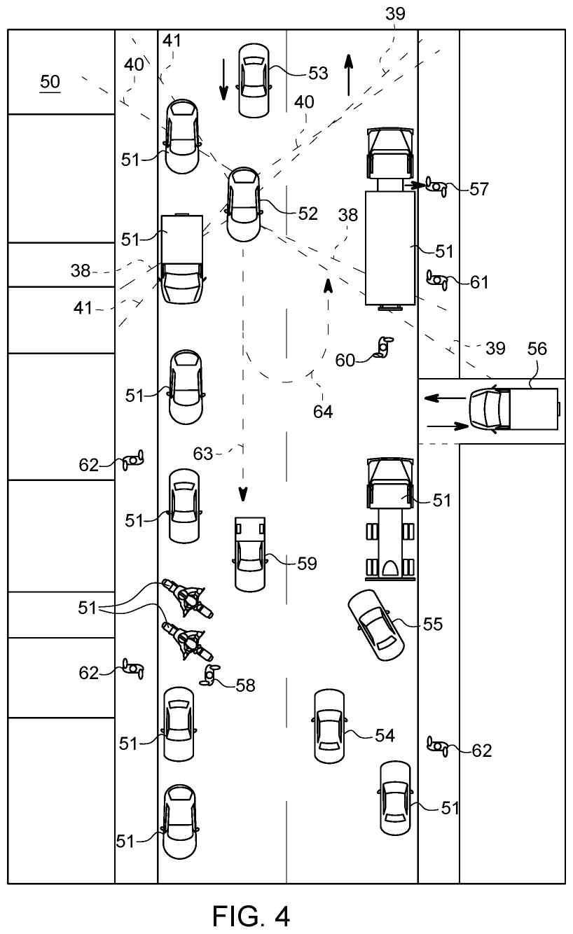

FIG. 4 depicts a u-turn executed on a typical city street like that of FIG. 2. A common u-turn scenario is shown for this city street [50], with numerous curbside parallel parked cars [51], a motor vehicle executing a u-turn in middle of city street [52], a motor vehicle following the vehicle making a u-turn [53], a motor vehicle traveling on other side of street in opposing traffic [54], a motor vehicle on the other side of street pulling out of parallel curb-side parking spot directly into traffic opposing the u-turning vehicle, where this vehicle's path will cross the path of the u-turning vehicle [55], a motor vehicle pulling out of driveway, where this vehicle's path will cross the u-turning vehicle's path [56], pedestrians walking on the sidewalk with line-of-sight to the u-turning vehicle with lighted u-turn signal lights of embodiments of this invention [57], a pedestrian crossing the street with potential temporarily obscured view of the u-turning vehicle with lighted u-turn signal lights of embodiments of this invention [58], a vehicle traveling ahead of the u-turning vehicle [59], a pedestrian crossing the street, in the middle of the street, Jay Walking, heading into the path of the u-turning vehicle [60], a pedestrian with a temporarily obscured view of the u-turning vehicle with lighted u-turn signal lights of embodiments of this invention [61], various pedestrians walking on the sidewalk [62], the expected path of a u-turning vehicle with u-turn signal lights of embodiments of this invention that have not been turned on [63], and the expected path of the u-turning vehicle with lighted (i.e., turned on) u-turn signal lights of embodiments of this invention [64].

FIG. 4 further shows the interaction of the participants in a typical congested city street [50}, with multiple parallel parked motor vehicles shown on both sides of the street [51]. The driver of a vehicle [52], utilizing an installed, turned-on u-turn signal device of embodiments of this invention is executing a u-turn not at an intersection (as in FIGS. 1 and 3), but in the middle of the street. The dashed lines show the field-of-view of each of the lighted u-turn signal lights of a device of this invention. The forward-facing u-turn signal light of the device field-of-view is shown [38]. The driver-side u-turn signal light of the device field-of-view is shown [39]. The rear-facing u-turn signal light of the device field-of-view is shown [40]. The u-turning vehicle right-side-facing u-turn signal light of the device field-of-view is shown [41].

As can be seen in FIG. 4, based on the size and position of parked and approaching vehicles, some visibility of the u-turn signal lights may be temporarily obscured until motion of the various vehicles and pedestrians eventually bring the signal lights into view. A pedestrian [61] is temporarily out of the field of view of the u-turning vehicle while another pedestrian [57] has a field of view that includes the u-turning vehicle. The driver of the u-turning vehicle enables the u-turn signal device embodiment of this invention, installed in the vehicle, and, also signals a left turn using the vehicle turn signal. A minimum installation of the forward facing, driver-side facing and the rear facing lighted u-turn signal lights of the device, on the u-turning vehicle, provides effective multi-directional warning for the most at-hazard vehicles and pedestrians affected by the u-turn. By adding a fourth lighted u-turn signal light to the device, installed with a field of view out of the right side of the u-turning vehicle, this creates a true and/or effectively omnidirectional warning signal.

This omnidirectional signal minimizes the hazards associated with u-turns and can warn other drivers and pedestrians that the u-turning driver may not ordinarily consider. A vehicle [53] is following the u-turning vehicle. A vehicle [59] is driving ahead of the u-turning vehicle and may temporarily obscure the u-turn signal light from various vehicles and a pedestrian [58]. A vehicle is approaching the u-turning vehicle [54]. Various pedestrians are walking on the sidewalks [62]. A vehicle [55] is pulling out of a parallel parked position in the direction of the path of the u-turning vehicle. A vehicle [56] is pulling out of a driveway in the direction of the path of the u-turning vehicle. A pedestrian [60] is attempting to cross the street, in the middle of the street, Jay Walking, into the path of the u-turning vehicle. With the u-turn signal lights of the device of an embodiment of this invention turned off, all drivers and pedestrians, on the street, assume the u-turning vehicle [52] will be continuing straight down the street as shown [63].

This discontinuity of expectations creates hazards for u-turning vehicles, pedestrians and, also for the other vehicles and pedestrians interacting with the u-turning vehicle. By utilizing the four u-turn signal lights of the device of this invention, all pedestrians and all competent, un-impaired and undistracted drivers, within the 360 degree omnidirectional effective field-of-view, and having direct line-of-sight to the u-turning vehicle, all understand that the u-turning vehicle will be taking the path shown [64]. This community understanding, of the intentions of the u-turning driver, reduces hazard and enhances driving safety. The Jay Walking pedestrian [60] will see the lighted u-turn signal light and stop and wait for the u-turning vehicle to complete the u-turn before attempting, again, to cross the street. The driver of vehicle [53], following the u-turning vehicle [52], will see the lighted u-turn signal light and slow-down or stop to allow the driver the complete the u-turn. The driver of the vehicle pulling out of the driveway [56] will see the lighted u-turn signal light and delay exiting the driveway until the u-turning vehicle has completed the u-turn and driven away. The drivers of approaching vehicles [54] and [55] will see the lighted u-turn signal light and slow down, allowing the u-turning vehicle to complete the u-turn and drive away. The u-turn signal lights of the device of this embodiment of the invention will also afford the same safety enhancements during the execution of three point (“Broken-K”), u-turns, where the driver executing the turn does not complete the turn smoothly and must stop and back-up in order to complete the maneuver.

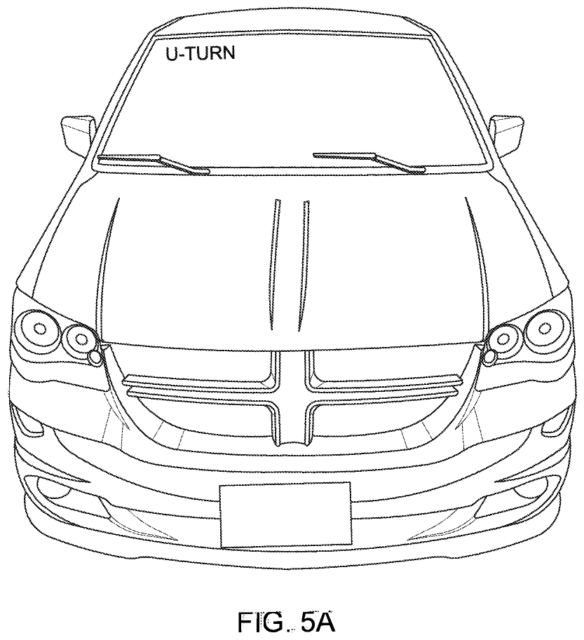

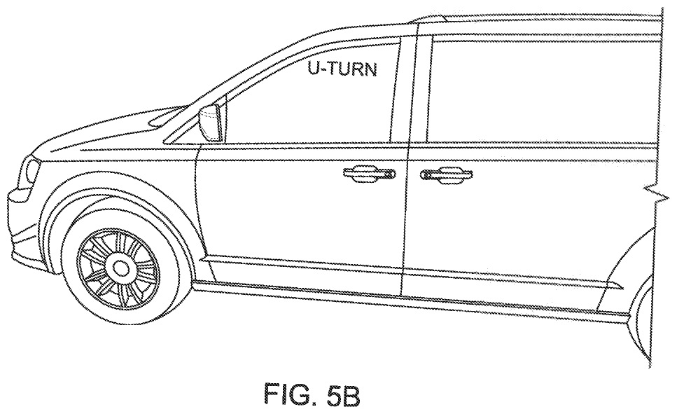

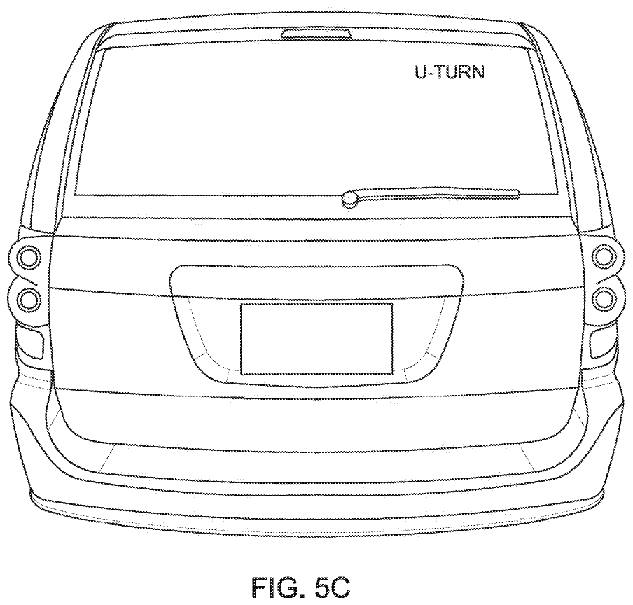

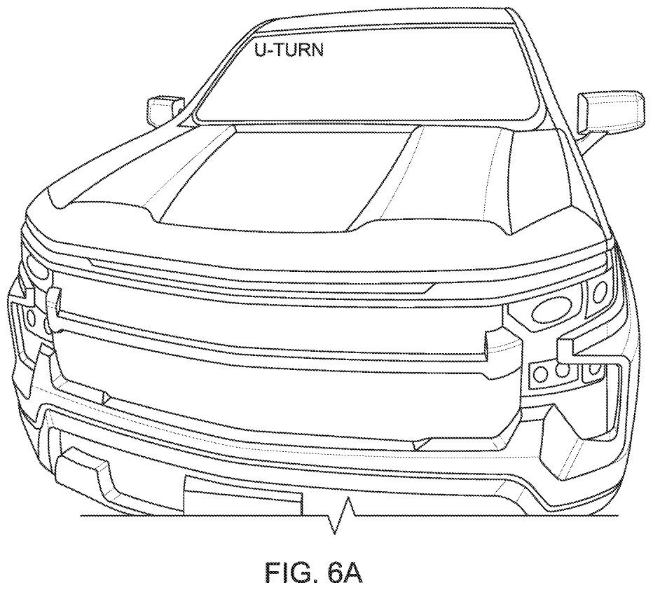

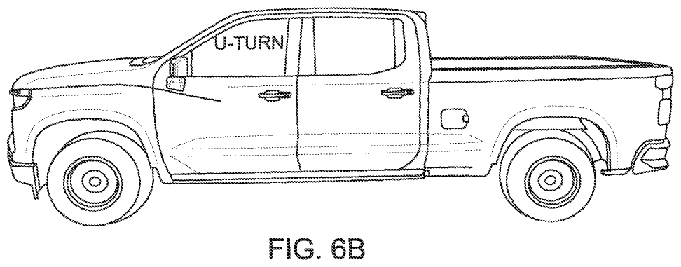

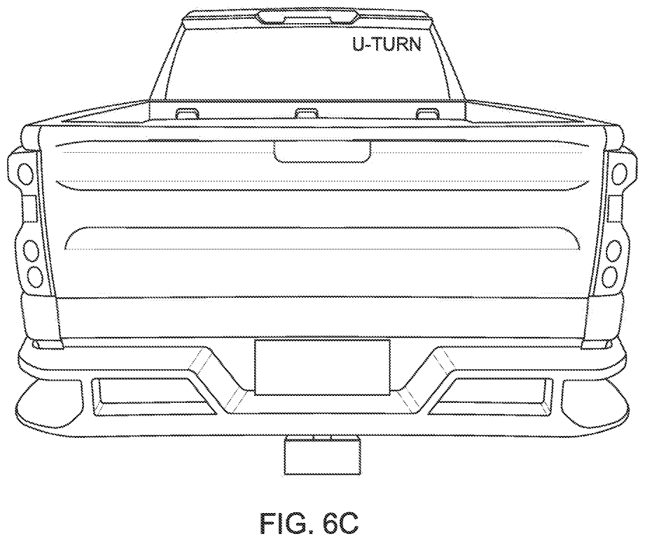

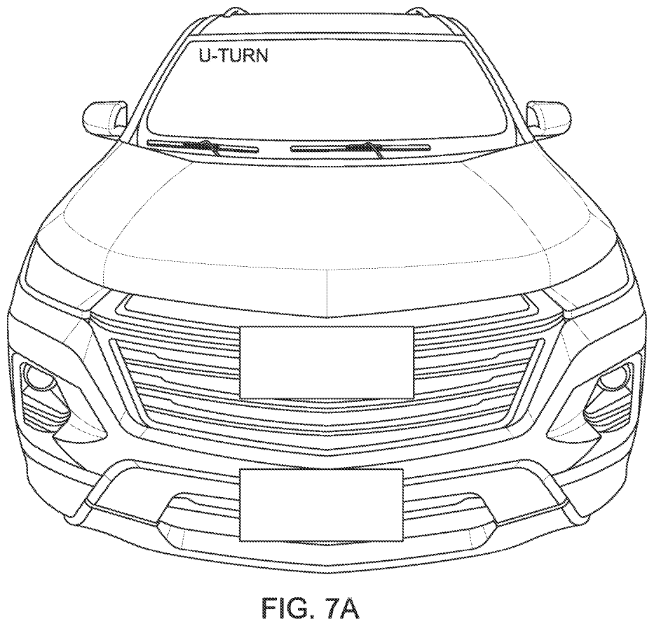

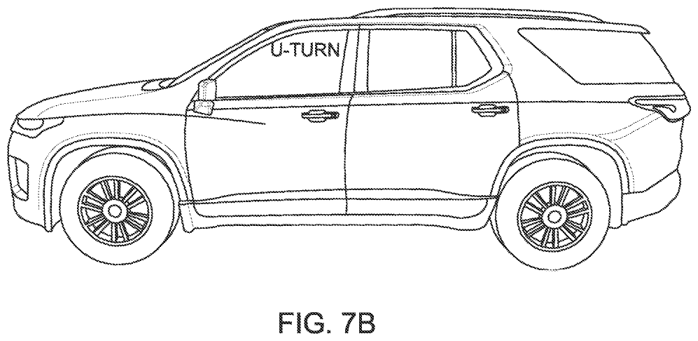

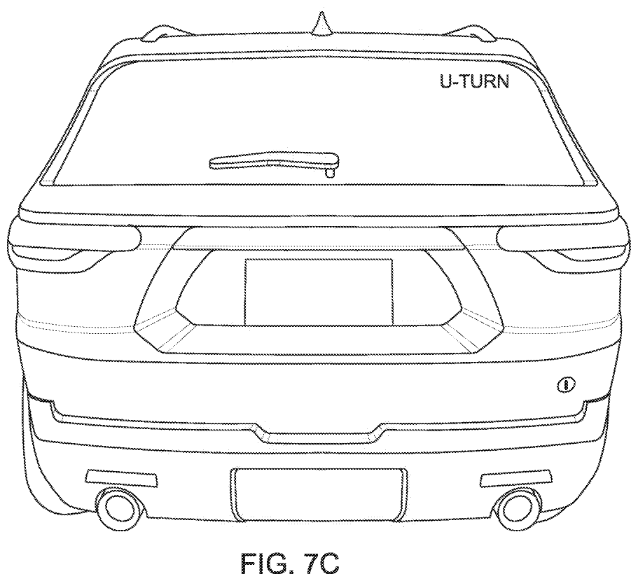

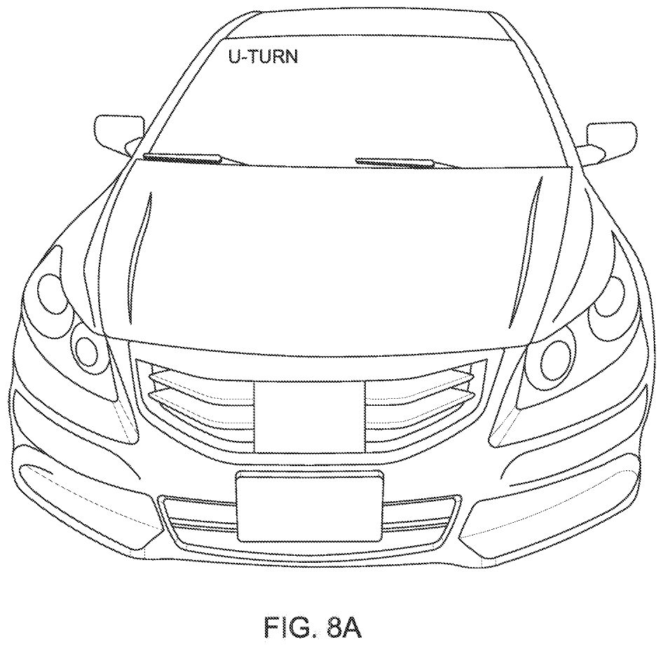

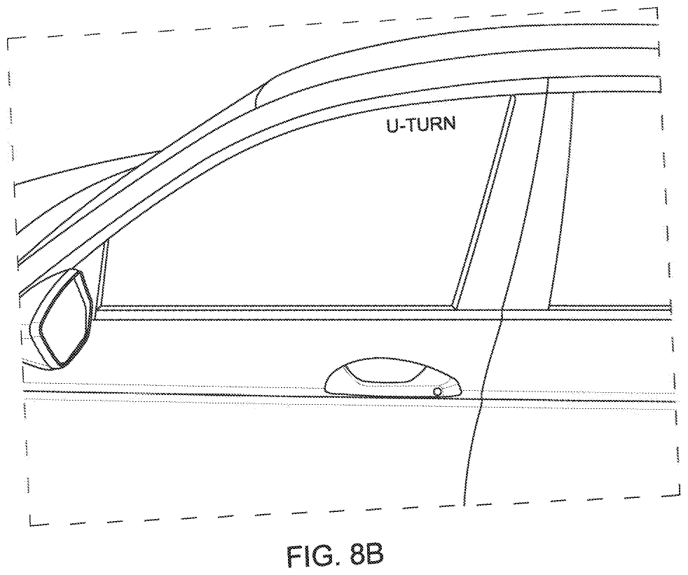

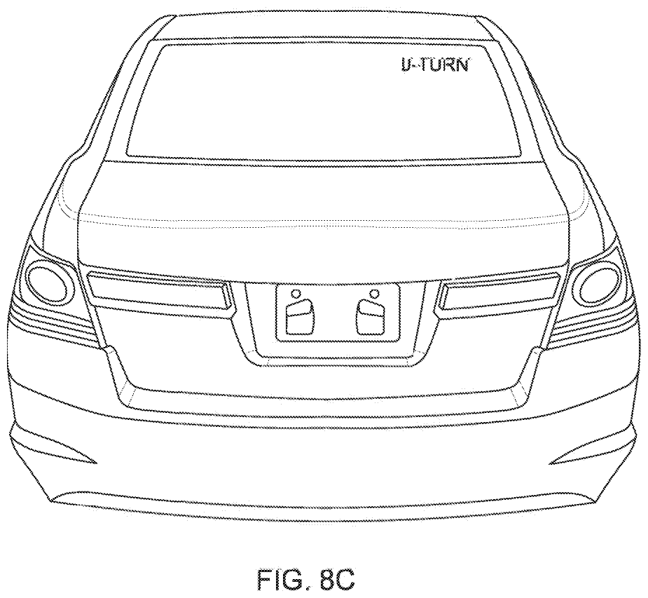

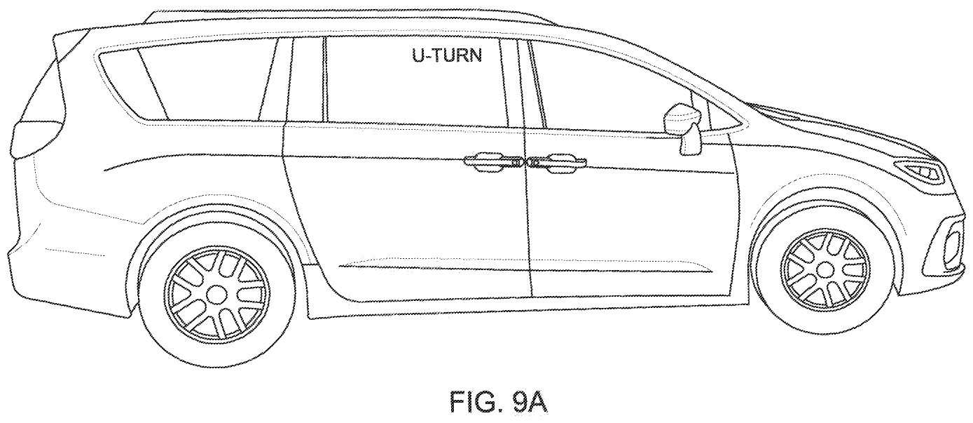

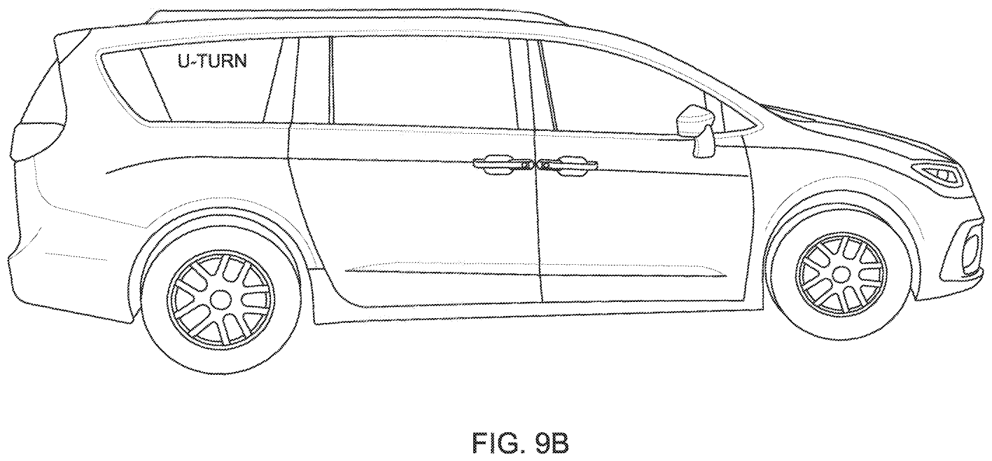

FIGS. 5 through 9 show various installations of u-turn signal light embodiments of this invention on various motor vehicles. FIGS. 5A-5C show views of a mini-van motor vehicle (A: front, B: driver's side, C: rear window), with potential placements of u-turn signal lights of embodiments of this invention. FIGS. 6A-6C show views of a pick-up truck motor vehicle (A: front, B: driver's side, C: rear window), with potential placements of u-turn signal lights of embodiments of this invention. FIGS. 7A-7C show views of an SUV motor vehicle (A: front, B: driver's side, C: rear window), with potential placements of u-turn signal lights of embodiments of this invention. FIGS. 8A-8C show views of a sedan motor vehicle (A: front, B: driver's side, C: rear window), with potential placements of u-turn signal lights of embodiments of this invention. FIGS. 9A-9B show views of motor vehicles, with potential placements of u-turn signal lights of embodiments of this invention (A: passenger side middle window placement, B: passenger side back window placement).

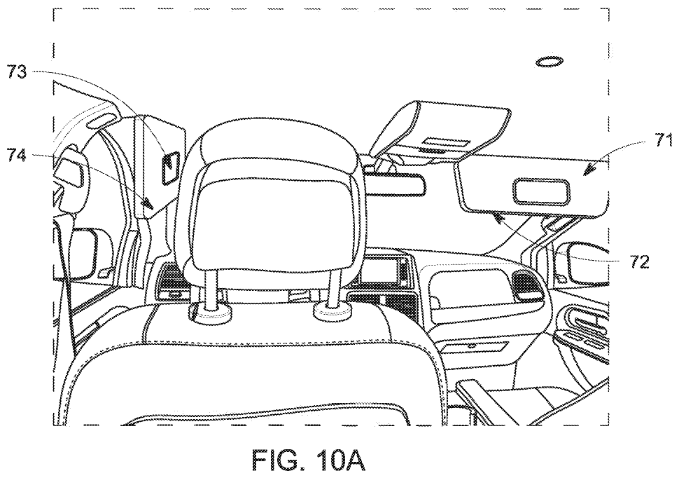

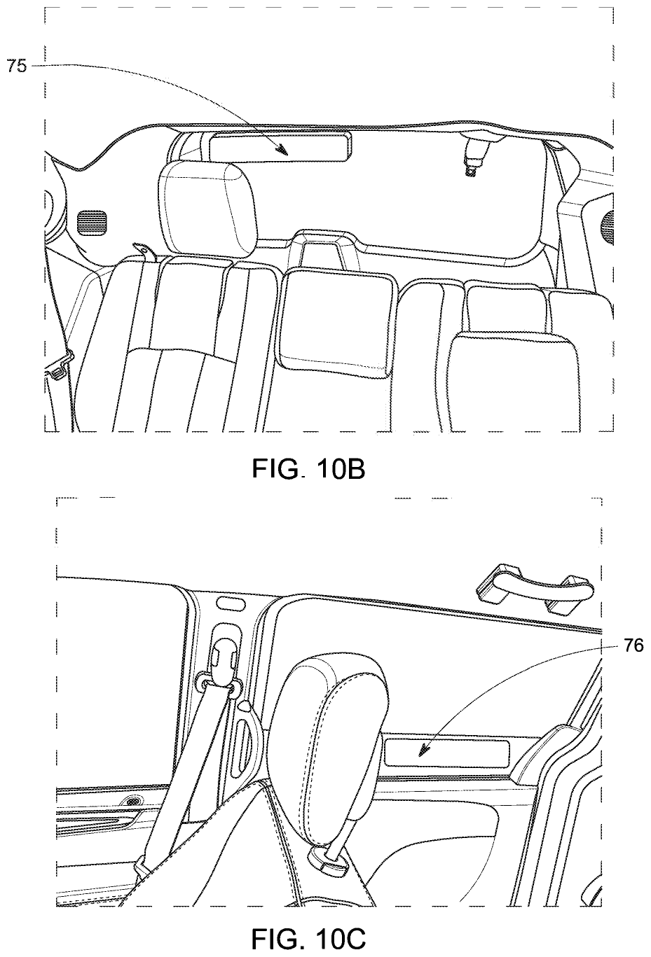

FIGS. 10A-10C show aspects of the device relating to the interior of a motor vehicle and potential placement of u-turn signal lights. In particular, FIGS. 10A-10C show views (A: looking forward from a rear seat, B: looking towards the rear from a front seat; C: looking at the side of the vehicle) of the interior of a motor vehicle and the placement of components of a u-turn signal device embodiment of this invention. A friction mounting provision for an embodiment of a mounted u-turn signal light, of a device of this invention, is shown attached to the vehicle front passenger side sun visor [71]. The location of a mounted u-turn signal light of a device of this invention on a front passenger side sun visor is also shown [72]. A friction provision to mount a u-turn signal light of a device of this invention attached to the vehicle front driver side sun visor is also shown [73]. The location of a mounted u-turn signal light of a device of this invention on the front driver side sun visor is also shown [74]. The location of a rear mounted u-turn signal light of a device of this invention adhered or otherwise affixed to the rear window is also shown [75]. The location and optional mounting of a u-turn signal light of a device of this invention on vertical open and closed vehicle side windows where the window does not roll completely down is also shown [76].

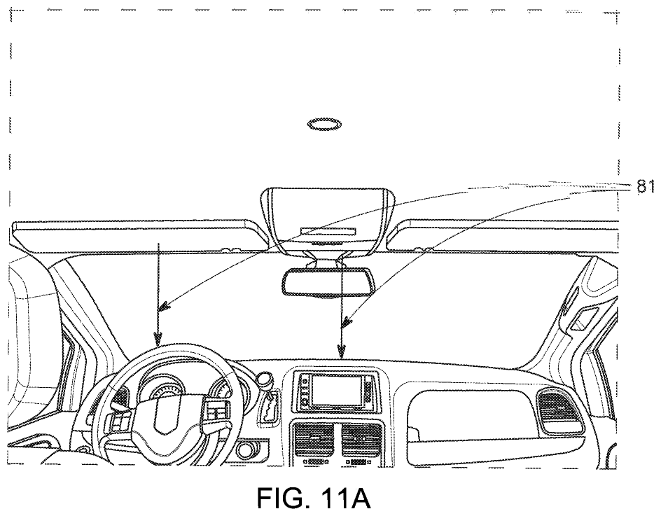

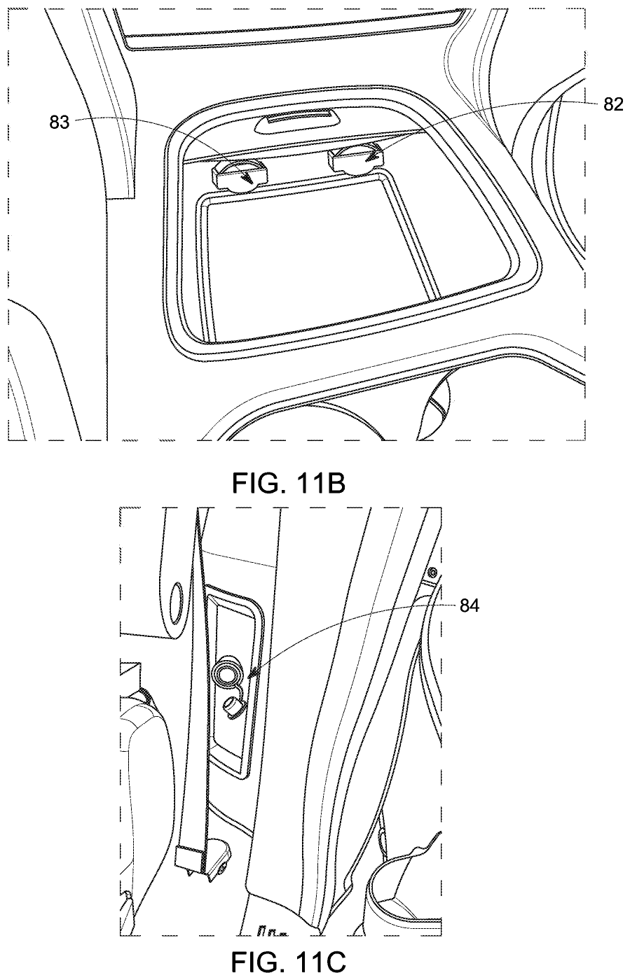

FIGS. 11A-11C show aspects of the device relating to the interior of a motor vehicle and potential placement of components of the device. In particular, FIGS. 11A-11C show views (A: looking forward from a rear seat, B: looking into a console between the front seats; C: looking at the interior driver side middle seats from the passenger side outside the vehicle open door.) of the interior of a motor vehicle and the placement of components of a u-turn signal device embodiment of this invention. Optional placements for a toggle switch controller, on the vehicle dash board, of an embodiment of a u-turn signal device of this invention is shown [81]. It is designed to be plugged into the motor vehicle interior electrical outlets. Examples of the typical location of automobile forward passenger compartment electrical outlets are shown [82], [83], as well as the typical location of automobile rear passenger compartment electrical outlets [84]. The device of this invention may get its electrical power from such electrical outlets in certain embodiments.

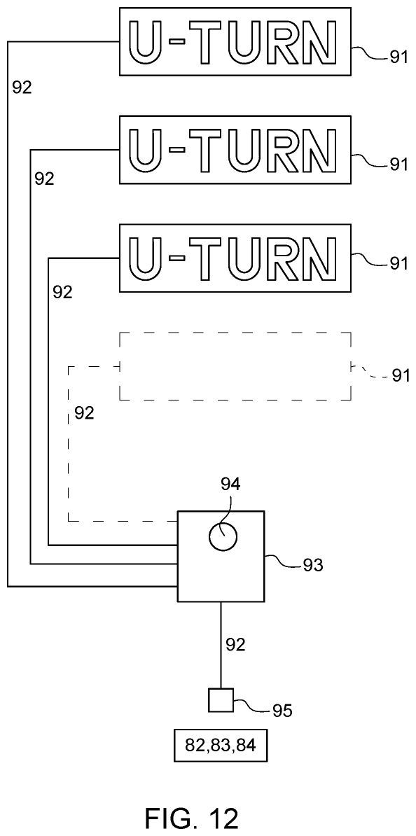

FIG. 12 is a schematic of an electrical circuit connecting components of embodiments of this invention, using wired components. A u-turn signal device is depicted, with one embodiment of a u-turn signal light that is to be affixed to a vehicle sun visor, and the other embodiment where a u-turn signal light is adhered or affixed to the vehicle windows [91]. Also shown is interconnected wiring [92], a controller containing control electronics [93], a toggle switch (e.g., press once to turn on the device, press once to turn off the device) [94], and a plug for use in the vehicle passenger compartment electrical outlets that provides electrical power from the motor vehicle to operate the device [95], along with depictions of potential vehicle passenger compartment electrical outlets that can be used [82], [83], [84] with the plug [95].

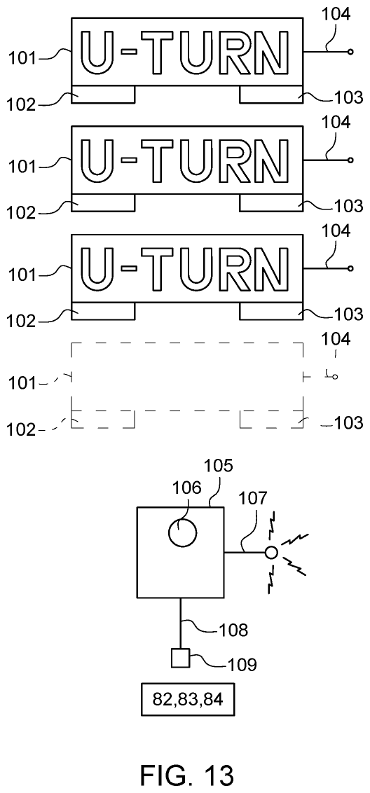

FIG. 13 is a schematic of an electrical circuit connecting components of embodiments of this invention, using certain wireless components. A u-turn signal device is depicted, with one embodiment of a u-turn signal light that is to be affixed to the vehicle sun visors, and the other embodiment where a u-turn signal light is adhered or affixed to the vehicle windows [101]. Also shown is a battery [102], wireless receiver electronics [103], a wireless receiver [104], a u-turn signal device wireless controller containing control electronics [105], a toggle switch (e.g., press once to turn on the device, press once to turn off the device) [106], a wireless transmitter [107], wiring [108], a plug for vehicle passenger compartment electrical outlets that provides electrical power from the vehicle to operate the device [109], along with depictions of potential vehicle passenger compartment electrical outlets that can be used [82], [83], [84] with the plug [109].

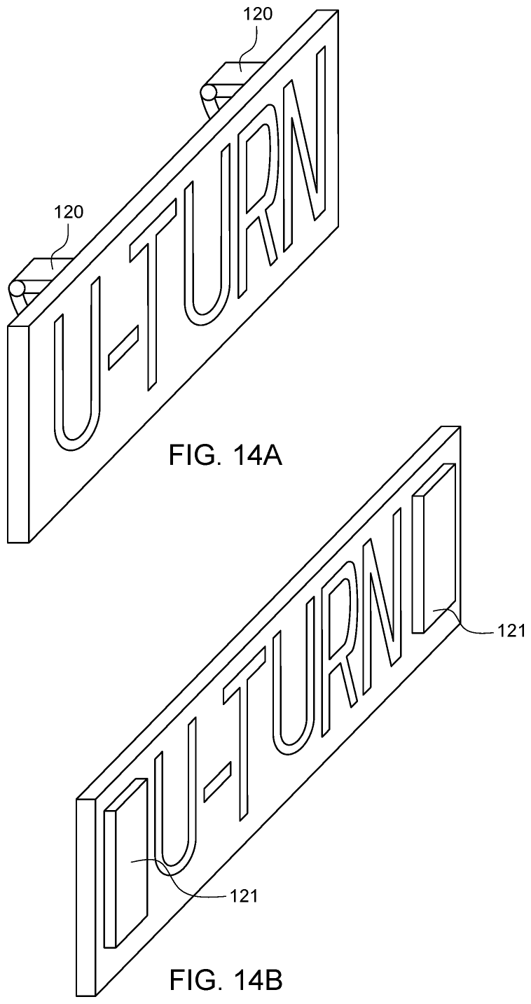

FIG. 14 shows embodiments regarding the provisions to mount the lighted signal devices inside the passenger compartment of the motor vehicle. FIG. 14A shows a perspective view of a u-turn lighted signal device to be mounted on motor vehicle driver side and front passenger side visors. FIG. 14 B shows a perspective view of a u-turn lighted signal device to be mounted on motor vehicle passenger compartment windows. In FIG. 14A, a provision is utilized to attach the lighted signal device to the driver side and front passenger side visor [120] in such a manner so that the lighted signal devices are securely affixed to the visors but that can also be easily and readily removed and reinstalled onto the visor. This provision may be a clip, band, or other similar provision. In FIG. 14B, a provision is utilized to attach the lighted signal device to the interior surfaces of the passenger compartment windows [121] in such a manner so that the lighted signal devices are securely affixed to the windows but that can also be easily and readily removed and reinstalled onto the windows. The provision may be an adhesive arrangement, hook and fastener material, or similar provision.

The subject matter of this disclosure is now described with reference to certain preferred embodiments. The preferred embodiments description is provided for the purpose of illustration only, and the subject matter is not limited to the examples provided, but rather encompasses all variations which are evident as a result of the teaching provided herein.

In the most preferred embodiments, the u-turn signal devices of this invention are used to provide an omnidirectional, or practically or effectively omnidirectional, warning to those outside of the motor vehicle when the motor vehicle is making a u-turn. In addition, multi-directional embodiments are also disclosed.

The u-turn devices comprise components that are placed and operated entirely within the passenger interior compartment of the motor vehicle. One u-turn signal light is affixed or otherwise attached to a rear vehicle window on the interior of the motor vehicle. A second and a third u-turn signal light are affixed or otherwise attached to both of the vehicle sun visors using a friction fit or other attachment hardware. Additional u-turn signal lights may be used in different locations (e.g., side windows). The u-turn signal lights use a steady or flashing light signal that reads “U TURN” and that can be visible to those outside of the vehicle for a distance that provides adequate warning that the motor vehicle is taking a u-turn.

In certain embodiments, the devices can be plugged into a pre-existing electrical outlet in the motor vehicle to power the devices and all of their components. In preferred embodiments of these, the devices can be set-up and interconnected (e.g., with wired and/or wireless components) by a layperson, without requiring the aid of a professional automobile service person. In these embodiments, a toggle switch is provided within easy reach of the motor vehicle driver, to turn the device on and off.

In the most preferred embodiments of this example, the devices are provided in the form of a kit and is installed and operated completely within a motor vehicle passenger compartment. In particular, a single installation will comprise four u-turn signal lights, each individually mounted and interconnected. Each individual u-turn signal light will have the word “U-TURN” spelled-out using steady and/or flashing LEDs or other suitable light source. One u-turn signal light will be mounted on the interior facing side of the driver-side sun visor. One u-turn signal light will be mounted on the exterior facing side of the front passenger-side sun visor. Note that the sun visor mounted u-turn signal lights shall install via slip-on friction fit. No tools should be required to perform this installation. The third u-turn signal light will be affixed to the interior rear window or adhered (e.g., using adhesive, using hook and fasteners) to the inside of the rear window. The fourth u-turn signal light will be affixed to a passenger side side window using adhesive or hook and fastener. The use of only three u-turn signal lights (forward facing, driver side facing and rear facing) is a viable and safe alternative that affords multidirectional (not omnidirectional) u-turn signal coverage around the vehicle.

To operate the devices the driver will simply lower the passenger-side sun visor, lower and rotate the driver-side sun visor (so that the lighted signal is showing through the driver-side front door window), and press a toggle switch (or equivalent device), affixed, or adhered to the dash, or within reach of the driver, only one time. This enables a warning for any approaching vehicle, following vehicle, or any vehicle, pedestrian, bicyclist/scooter, skater or other vehicle or person, who would be in the path of the u-turn. To turn the device off (after the successful, safe u-turn), the driver will simply press the toggle switch one time, and return the sun visors to their stowed positions (if desired).

Since the devices are completely mounted in the car passenger compartment there is no need for extreme, costly ruggedization. The u-turn signal lights shall be designed to be easily removed and reinstalled into the car. This will allow avoidance of damage from extreme heat and subfreezing temperatures. There is also no need for professional installation. This design is envisioned in two major embodiments: hard wired and wireless installation. Both will be designed for layperson installation. Electrical power for operation of the devices are provided by plugging the devices into one of the passenger compartment electrical outlets (these typically operate at 12.5 Volts), for the hard wired embodiments; Or using battery power, for each u-turn signal lights, for the wireless embodiments.

All embodiments of this invention are usuable in countries such as the United States where the driving convention is driver seated left and keep right, and also, in countries, such as the United Kingdom where the driving convention is driver seated right and keeps left. No modification will be required to the the devices of this invention to incorporate it into either of these motor vehicle types, or to operate it in either of these driving conventions.

Certain embodiments of this invention utilize only three u-turn signal lights (one facing forward, one facing the driver's side and a third facing the rear of the motor vehicle). This creates a safe multidirectional u-turn signal to those vehicle operators and pedestrians directly in the vicinity of the u-turning vehicle. Still another embodiment may include one, and possibly more, u-turn signal lights that are mounted to the exterior of a vehicle trailer. The exterior mounted u-turn signal light is required to be designed and fabricated with additional ruggedization to operate reliably in extreme temperatures and weather conditions. Still another embodiment will require the u-turn signal lights, and other device components, to be hard-wired into an automobile vehicle wiring during the motor vehicle manufacture or refurbishment.

### ILLUSTRATIVE EXAMPLES

Omnidirectional or multidirectional u-turn warning signal devices are provided that can be turned on and off. They are for a motor vehicle operated by a driver and the motor vehicle comprises an exterior with a rear portion, one or two sun visors, and an interior passenger compartment that comprises at least a front window, two side windows, and a rear window. In certain embodiments, the interior passenger compartment also comprises at least one electrical outlet capable of providing electrical power to the device. These electrical outlets can be outlets for mobile phone chargers or cigarette lighters and are usually 12 Volt. Alternatively, in more permanent installations, the signal device can be hardwired into the motor vehicle's wiring harness.

Preferred signal device can comprise several components that include (a) at least one electrical connector that is capable of connecting to at least one electrical outlet of the interior passenger compartment to provide electrical power (e.g., from the motor vehicle's battery, generator, or alternator) to the signal device (i.e., if the signal device is not hard-wired to the motor vehicle); (b) at least three light emitters (four and even more are more preferred than three to provide more effective warning of a u-turn) that when the signal device is turned on and provided with electrical power the light emitters emit light; and (c) at least one triggering device (e.g., an on/off switch) that is capable of turning on the signal device.

Once the triggering device turns on the signal device, each of the light emitters emit light and communicate to other drivers and pedestrians within about 270 to about 360 degrees (e.g., preferably 300-360 degrees, more preferably 320-360 degrees, most preferably 340 to 360 degrees) and within at least about 100 feet (e.g., preferably within at least 50-100 feet, more preferably within at least 100-250 feet, and most preferably within at least 100-500 feet) of the motor vehicle that the motor vehicle driver intends to take a u-turn. It is most preferred that all or at least most of the drivers and pedestrians within the immediate vicinity of the motor vehicle be able to see a light emitter of the signal device to be warned that the driver intends to take a u-turn. In these embodiments, the signal device is completely installed within the interior passenger compartment of the motor vehicle. The word “about” used herein generally means+ or − about 15%, as applicable to the value.

It is preferred that these embodiments be easy to install by a person without training. Most preferred is if these can be installed by a person without mechanical training in less than about 30 minutes (e.g., 20-40 minutes). These embodiments can also comprise an assemblage of interconnected wiring that connects at least the electrical connector, the light emitters and the triggering device together. In other embodiments, wireless connections (e.g., receive and send wireless signals) are provided between at least one of the light emitters and the triggering device.

Certain of these embodiments can be installed when the motor vehicle is being manufactured or remodeled or repaired. In other embodiments, the electrical connector, light emitters, and triggering device and other components are provided in the form of a kit that can be installed in the motor vehicle. It is preferred that the kit be installable by a person who is not a mechanic.

The triggering device can be of any type of switch, such as switches commonly used in motor vehicles. One embodiment is an on-off toggle switch control that the driver can operate by pressing to turn the signal device on and off, with one press of the on-off toggle switch control turning the signal device on and a second press of the on-off toggle switch turning the signal device off. The electronic controls (e.g., switches, circuits, chips) for the signal device can be provided in a housing with the triggering device in certain embodiments.

The light emitters (e.g., LED's) preferably emit light that is visible to read “U TURN”. The light can have a color, such as red or yellow or another color, and it is preferred if it gets the attention of those people near the motor vehicle that would benefit from being informed that the driver intends to take a u-turn. Thus, the emitted light may be flashing or it may be constant or it may have adjustable intensity. The signal device may permit the driver to choose which in some embodiments.

The light emitters can be mounted by various hardware known to a person of skill in the art. One such choice can be a friction grip mounting wherein at least one light emitter is reversibly (e.g., readily installed and uninstalled) mounted on at least one of the sun visors of the motor vehicle using the friction grip mounting. Another choice can be a window mounting wherein at least one light emitter is reversibly mounted on the front, side or rear windows of the interior passenger compartment vehicle using the window mounting. Still another choice can be a mounting that attaches a light emitter to the exterior of the motor vehicle or a trailer being pulled by the motor vehicle. In these exterior installations, the exterior mounting and the light emitter are preferably ruggedized to withstand extremes of temperature and weather. Other mountings can be used as will be understood by a person skilled in the art.

In a highly preferred embodiment providing for almost about 360 degree warning, one light emitter is mounted on each of the sun visors, one light emitter is mounted on a passenger-side window of the interior passenger compartment, and one light emitter is mounted on the rear window of the interior passenger compartment, wherein each light emitter is facing the exterior of the motor vehicle and thereby is visible outside of the motor vehicle.

In another embodiment, a light emitter is mounted on the front window of the interior passenger compartment, a light emitter is mounted on each of the two side windows of the interior passenger compartment, and a light emitter is mounted on the rear window of the interior passenger compartment, wherein each light emitter is facing the exterior of the motor vehicle and thereby is visible outside of the motor vehicle.

In still another embodiment, one light emitter is mounted on one of the sun visors, a light emitter is mounted on each of the two side windows of the interior passenger compartment, and a light emitter is mounted on the rear window of the interior passenger compartment, wherein each light emitter is facing the exterior of the motor vehicle and thereby is visible outside of the motor vehicle.

In some embodiments at least one light emitter may be installed on the exterior of the motor vehicle and/or in the interior passenger compartment. In certain of these embodiments, the motor vehicle further comprises a trailer with a rear surface and at least one light emitter is attached to the rear surface (and sides, in some applications) of the trailer. For other vehicles, such as box vans, additional exterior light emitters can be installed on the sides as well as the rear of the vehicle.

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

As used in this specification and the appended claims, the singular forms “a” and “an” indicate a single element, while “the” may refer back to single or plural referents. Unless defined otherwise, all technical and scientific terms used herein have the same meaning as commonly understood by one of ordinary skill in the art to which the disclosure pertains.

The above detailed description of exemplary and preferred embodiments is presented for the purposes of illustration and disclosure in accordance with the requirements of the law. It is intended to be exemplary but not exhaustive, and is not intended to limit the invention to the precise forms described, but only to enable others skilled in the art to understand how the invention may be suited for a particular use of implementation. No limitation is intended by the description of exemplary embodiments which may have included tolerances, feature dimensions, specific operating conditions, engineering specifications, or the like, and which may vary between implementations or with changes to the state of the art, and no such limitation should be implied therefrom. Applicant has made this disclosure with respect to the current state of the art, but also contemplates advancements and that adaptations in the future may take into consideration those advancements in accordance with the then current state of the art. It is intended that the scope of the invention be defined by the Claims as written and equivalents as applicable. Reference to a claim element in the singular is not intended to mean “one and only one” unless explicitly so stated. No claim element herein is intended to be construed under the provisions of 35 U.S.C. 112(f), unless the element is expressly recited using the exact phrase “means for . . . ” and no method or process step herein is to be construed under the provisions of 35 U.S.C. section 112(f) unless the step, or steps, are expressly recited using the exact phrase “step(s) for . . . .”

1. A u-turn warning signal device that can be turned on and off for a motor vehicle operated by a driver, the motor vehicle comprising an exterior with a rear, two sun visors, and an interior passenger compartment comprising a front window, two side windows, and a rear window, the interior passenger compartment also comprising at least one electrical outlet capable of providing electrical power, the signal device comprising:
(a) at least one electrical connector that is capable of connecting to the at least one electrical outlet of the interior passenger compartment to provide electrical power to the signal device;
(b) at least three light emitters that when the signal device is turned on and provided with electrical power the light emitters emit light;
(c) at least one triggering device that is capable of turning on the signal device;
(d) wherein once the triggering device turns on the signal device, each of the light emitters emit light and communicate to other drivers and pedestrians within about 270 to about 360 degrees and within at least about 100 feet of the motor vehicle that the motor vehicle driver intends to take a u-turn; and
(e) wherein the signal device is completely installed within the interior passenger compartment of the motor vehicle.

2. The signal device of claim 1 that can be installed by a person without mechanical training in less than about 30 minutes.

3. The signal device of claim 1 further comprising an assemblage of interconnected wiring that connects at least the electrical connector, the light emitters and the triggering device together.

4. The signal device of claim 1 further comprising wireless connections between at least one of the light emitters and the triggering device.

5. The signal device of claim 1 wherein it is installed when the motor vehicle is being manufactured.

6. The signal device of claim 1 wherein the electrical connector, light emitters, and triggering device are provided in the form of a kit that can be installed in the motor vehicle.

7. The signal device of claim 1 wherein the triggering device is an on-off toggle switch control that the driver can operate by pressing to turn the signal device on and off, with one press of the on-off toggle switch control turning the signal device on and a second press of the on-off toggle switch turning the signal device off.

8. The signal device of claim 1 further comprising electronic controls for the device that are provided in a housing with the triggering device.

9. The signal device of claim 1 wherein at least one of the light emitters emit light that is visible to read “U TURN”.

10. The signal device of claim 9 wherein the emitted light is flashing.

11. The signal device of claim 9 wherein the emitted light is constant.

12. The signal device of claim 1 further comprising a friction grip mounting wherein at least one light emitter is reversibly mounted on at least one of the sun visors of the motor vehicle using the friction grip mounting.

13. The signal device of claim 1 further comprising a window mounting wherein at least one light emitter is reversibly mounted on the front, side or rear windows of the interior passenger compartment vehicle using the window mounting.

14. The signal device of claim 1 wherein a light emitter is mounted on the front window of the interior passenger compartment, one light emitter is mounted on each of the two side windows of the interior passenger compartment, and one light emitter is mounted on the rear window of the interior passenger compartment, wherein each light emitter is facing the exterior of the motor vehicle and thereby is visible outside of the motor vehicle.

15. The signal device of claim 1 wherein a light emitter is mounted on each of the sun visors, a light emitter is mounted on one of the side windows of the interior passenger compartment, and a light emitter is mounted on the rear window of the interior passenger compartment, wherein each light emitter is facing the exterior of the motor vehicle and thereby is visible outside of the motor vehicle.

16. The signal device of claim 1 wherein a light emitter is mounted on one of the sun visors, a light emitter is mounted on each of the two side windows of the interior passenger compartment, and a light emitter is mounted on the rear window of the interior passenger compartment, wherein each light emitter is facing the exterior of the motor vehicle and thereby is visible outside of the motor vehicle.

17. A u-turn warning signal device that can be turned on and off for a motor vehicle operated by a driver, the motor vehicle comprising an exterior with a rear, two sun visors, and an interior passenger compartment comprising a front window, two side windows, and a rear window, the interior passenger compartment also comprising at least one electrical outlet capable of providing electrical power, the signal device comprising:
(a) at least one electrical connector that is capable of connecting to the source of electrical power to provide electrical power to the signal device;
(b) at least three light emitters that when the signal device is turned on and provided with electrical power the light emitters emit light;
(c) at least one triggering device that is capable of turning on the signal device;
(d) wherein once the triggering device turns on the signal device, each of the light emitters emit light and communicate to other drivers and pedestrians within about 270 to about 360 degrees and within at least 100 feet of the motor vehicle that the motor vehicle driver intends to take a u-turn; and
(e) wherein the light emitters may be on the exterior of the motor vehicle and/or in the interior passenger compartment.

18. The signal device of claim 17 wherein at least one light emitter is attached to the exterior of the motor vehicle.

19. The signal device of claim 17 wherein the motor vehicle further comprises a trailer with a rear surface and at least one light emitter is attached to the rear surface of the trailer.

20. The signal device of claim 17 wherein the electrical connector is hard-wired to the source of electrical power.

21. The signal device of claim 17 that can be installed by a person without mechanical training in less than about 30 minutes.

22. The signal device of claim 17 further comprising an assemblage of interconnected wiring that connects at least the electrical connector, the light emitters and the triggering device together.

23. The signal device of claim 17 further comprising wireless connections between at least one of the light emitters and the triggering device.

24. The signal device of claim 17 wherein it is installed when the motor vehicle is being manufactured.

25. The signal device of claim 17 wherein the electrical connector, light emitters, and triggering device are provided in the form of a kit that can be installed in the motor vehicle.

26. The signal device of claim 17 wherein the triggering device is an on-off toggle switch control that the driver can operate by pressing to turn the signal device on and off, with one press of the on-off toggle switch control turning the signal device on and a second press of the on-off toggle switch turning the signal device off.

27. The signal device of claim 17 further comprising electronic controls for the device that are provided in a housing with the triggering device.

28. The signal device of claim 17 wherein at least one of the light emitters emit light that is visible to read “U TURN”.

29. The signal device of claim 28 wherein the emitted light is flashing.

30. The signal device of claim 28 wherein the emitted light is constant.

31. The signal device of claim 17 further comprising a friction grip mounting wherein at least one light emitter is reversibly mounted on at least one of the sun visors of the motor vehicle using the friction grip mounting.

32. The signal device of claim 17 further comprising a window mounting wherein at least one light emitter is reversibly mounted on the front, side or rear windows of the interior passenger compartment vehicle using the window mounting.

33. The signal device of claim 17 wherein one light emitter is mounted on the front window of the interior passenger compartment, one light emitter is mounted on each of the two side windows of the interior passenger compartment, and one light emitter is mounted on the rear window of the interior passenger compartment, wherein each light emitter is facing the exterior of the motor vehicle and thereby is visible outside of the motor vehicle.

34. The signal device of claim 17 wherein a light emitter is mounted on each of the sun visors, a light emitter is mounted on one of the side windows of the interior passenger compartment, and a light emitter is mounted on the rear window of the interior passenger compartment, wherein each light emitter is facing the exterior of the motor vehicle and thereby is visible outside of the motor vehicle.

35. The signal device of claim 17 wherein a light emitter is mounted on one of the sun visors, a light emitter is mounted on each of the two side windows of the interior passenger compartment, and a light emitter is mounted on the rear window of the interior passenger compartment, wherein each light emitter is facing the exterior of the motor vehicle and thereby is visible outside of the motor vehicle.

36. The signal device of claim 17 further comprising an exterior mounting wherein at least one light emitter is mounted on the exterior of the motor vehicle or a rear surface of a trailer the motor vehicle is pulling using the exterior mounting, and wherein the exterior mounting and the light emitter are ruggedized to withstand extremes of temperature and weather.

37. The signal device of claim 9 wherein the intensity of the emitted light is preset during manufacture and can not be adjusted by the u-turn signal device operator.

38. The signal device of claim 9 wherein the intensity of the emitted light is adjustable by the u-turn signal device operator.

39. The signal device of claim 28 wherein the intensity of the emitted light is preset during manufacture and cannot be adjusted by the u-turn signal device operator.

40. The signal device of claim 28 wherein the intensity of the emitted light is adjustable by the u-turn signal device operator.

41. The signal device of claim 9 wherein the color of the emitted light is preset during manufacture and cannot be adjusted by the u-turn signal device operator.

42. The signal device of claim 9 wherein the color of the emitted light is adjustable by the u-turn signal device operator.

43. The signal device of claim 28 wherein the color of the emitted light is preset during manufacture and cannot be adjusted by the u-turn signal device operator.

44. The signal device of claim 28 wherein the color of the emitted light is adjustable by the u-turn signal device operator.

45. The signal device of claim 4 wherein special features are designed into the wireless functionality such that when a driver turns-on the signal device, that another signal device, in a separate nearby vehicle, will not also be inadvertently be turned on.

46. The signal device of claim 1 wherein a light emitter is mounted on each of the sun visors and a light emitter is mounted on the rear window of the interior passenger compartment, wherein each light emitter is facing the exterior of the motor vehicle and thereby is visible outside of the motor vehicle.
